(19) United States
(12) Patent Application Publication
(10) Pub. No.: US 2012/0036086 A1
(43) Pub. Date: Feb. 9, 2012

(54) SYSTEM AND METHOD FOR MANAGEMENT OF INVESTMENT FUNDS

(75) Inventors: Edward C. Caputo, Canton, CT (US); William H. Davison, JR., Suffield, CT (US); Hugh Thomas More Whelan, West Hartford, CT (US)

(73) Assignee: Hartford Fire Insurance Company, Hartford, CT (US)

(21) Appl. No.: 12/851,982

(22) Filed: Aug. 6, 2010

(51) Int. Cl. G06Q 40/00

(52) U.S. Cl. 705/36 R

(57) ABSTRACT

A computer system for determining investment fund holdings of a fund of funds accesses data relating to holdings of investment funds over time and investment rules of the funds of funds. The computer system analyzes the holdings of the investment funds over time to obtain investment performance data of the investment funds by asset class and volatility data. Using the investment performance data of the investment funds by asset class, the volatility data, and investment rules of the fund of funds, the computer system determines a selection of investment funds for holdings of the fund of funds.

### FIELD OF INVENTION

The present invention relates to computer systems, and particularly to computer systems for management of investment funds.

### BACKGROUND

Investment funds operate on a variety of different models. Mutual funds invest assets directly in securities, such as stocks and bonds. Mutual funds that invest in securities may be classified generally in two categories: managed and index. Index funds model their holdings according to securities determined by an index intended to model an entire market, such as the S&P 500, or portions of a market defined by such categories as capitalization of issuers, portion of market, domestic or international, and numerous other asset classes. Managed funds include securities selected by fund managers. Managed funds typically invest in one asset class, or in more than one asset class in particular proportions.

Investment funds that invest in other investment funds are referred to as “funds of funds.” A fund of fund generally has a stated asset class or mix of asset classes. In selecting underlying funds for investment, managers of funds of funds consider performance of managers and diversification, among other goals. As the underlying funds may themselves have multiple investment objectives, determining the quality of management of an underlying fund in a given asset class requires associating returns of the underlying fund with the proper asset class. Diversification within an investment category is desirable to avoid losses or underperformance associated with one or a handful of securities. The selection of multiple underlying funds within an asset class does not necessarily imply that a fund of funds is diversified within that asset class. The underlying funds may have similarities in their securities holdings.

### SUMMARY

In one embodiment, a computer system for determining investment fund holdings of a fund of funds accesses data relating to holdings of investment funds over time and investment rules of the funds of funds. The computer system analyzes the holdings of the investment funds over time to obtain investment performance data of the investment funds by asset class and volatility data. Using the investment performance data of the investment funds by asset class, the volatility data, and investment rules of the fund of funds, the computer system determines a selection of investment funds for holdings of the fund of funds.

In an embodiment, the computer system may determine investment performance data based on excess returns compared to a benchmark in each asset class. The computer system may determine volatility data by determining covariances between investment performance of investment funds. The computer system may use investment rules of the fund of funds including rules as to asset class proportions and limitations on turnover of investment fund holdings.

### BRIEF DESCRIPTION OF THE FIGURES

FIG. 1 is a schematic diagram of an environment for implementation of a method and system of the invention.

FIG. 2 is a schematic diagram of an exemplary computer network for implementation of a method and system of the invention.

FIG. 3 is a schematic diagram of an exemplary computer system for use in the exemplary computer network of FIG. 2.

FIG. 4 is a schematic diagram of an exemplary computer system for implementation of a method and system of the invention.

FIG. 5 is an exemplary process flow diagram of an exemplary method of the invention.

FIG. 6 is an exemplary table showing weighted excess returns by asset class for selected funds.

FIG. 7 is an exemplary covariance matrix, indicating covariances of rolling excess return data between pairs of funds.

FIG. 8 is an exemplary correlation matrix, indicating correlations between excess return data for pairs of funds.

FIG. 9 is a table showing an exemplary allocation resulting from an embodiment of the optimization method disclosed herein.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for analyzing holdings of managed funds.

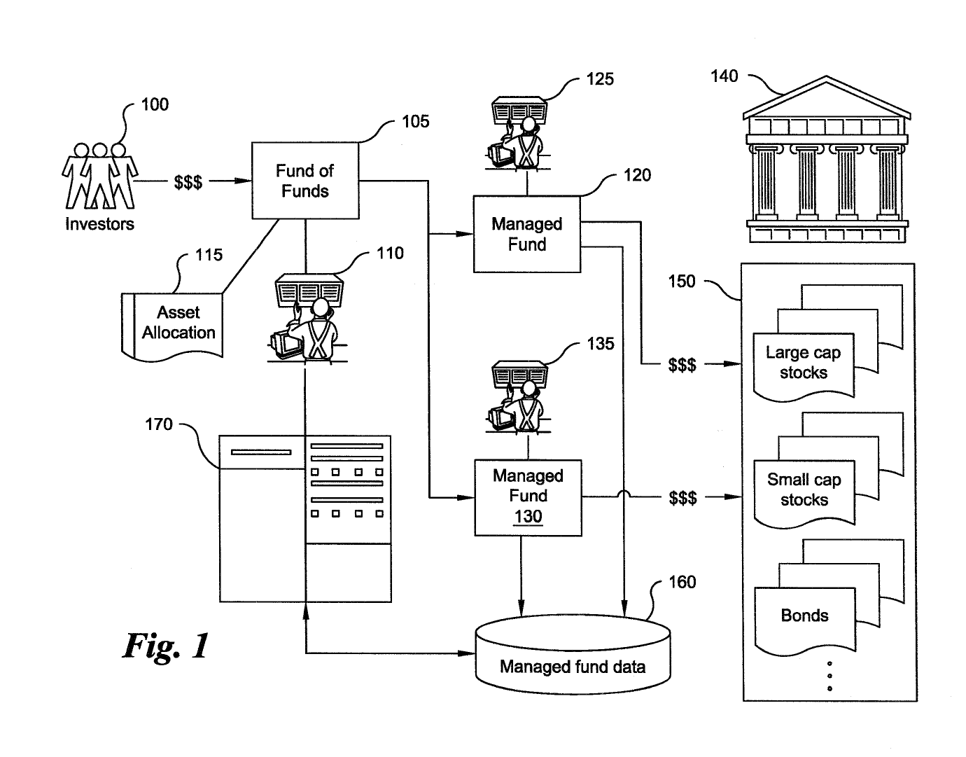

Referring now to FIG. 1, a high level view of an environment for implementation of a method and system that overcomes the problems encountered in the prior art is illustrated. The environment of FIG. 1 illustrates investors 100 who invest funds in a fund of funds 105. Fund of funds 105 is an investment fund, such as a hedge fund or a mutual fund, which places some or all of its investments in shares of other investment funds. Fund of funds 105 is managed by a manager 110. Fund of funds 105 has a desired or target asset allocation 115. Fund of funds 105 has investments in managed investment funds, represented in FIG. 1 by managed funds 120, 130. Managed fund 120 is managed by fund manager 125. Managed fund 130 is managed by fund manager 135. Managed funds 120, 130 are invested in securities that may be traded on markets, such as over-the-counter markets, or on exemplary exchange 140. Managed funds 120, 130 may also include exchange-traded funds (ETFs), for example. Examples of asset classes of securities are shown in block 150.

Managed funds 120, 130, furnish data relating to their holdings to managed fund database 160. Managed funds database 160 may include data as to, for each fund, values of holdings of each of the managed funds in each of several asset classes on certain dates. The data may be daily, weekly, monthly, or other periodic data. Computer system 170 is accessible by fund of funds manager 110 and has access to data in managed funds database 160.

Computer system 170 analyzes the holdings of managed funds 120, 130. The performance of each managed fund in each asset class may be compared to a benchmark to determine excess returns. The benchmark for each asset class may be an index of securities in the same asset class. The excess returns then reflect the difference between the return in an asset class for a particular managed fund, compared to an index of securities in that asset class. The excess returns accordingly reflect the effect of the skill of the manager of the managed fund in selecting securities. The returns may be weighted using various time periods, to obtain performance of the managed funds in each asset class over a variety of time periods, including short term performance, such as three months or six months, and long term performance, such as multi-year periods. Based on the weighted returns and a desired asset allocation, an optimal allocation of investment to funds is determined. The determination of the allocation to funds involves factoring in a reduction of volatility by determining which funds exhibit similar excess returns over a time period. A correlation matrix may be generated, indicative of similarity or dissimilarity between the excess returns over a time period. Within an asset class, volatility may be reduced by investing in funds having low correlation values. A high correlation value may also be indicative of fund managers having similar strategies or relying on the same sources for decisions.

Constraints may be provided on the selection of funds. Equality constraints include that the fund mix must sum to 100%, and the ratio of equity exposure to debt exposure for the fund of funds must be satisfied. Non-equality constraints may include limits on turnover of funds, maximum and minimum exposures to individual asset classes, and maximum and minimum exposures to categories of asset classes. The constraint as to maximum and minimum exposures to individual asset classes and maximum and minimum exposures to categories of asset classes may be implemented as target exposures with permitted ranges around the targets. A constraint to limit turnover of funds limits the frequency of reallocation among funds based on changes in results of the determination from one periodic calculation to a next periodic calculation. Categories of asset classes include two or more asset classes that share similarities, such as a domestic equity category that includes domestic large cap equity asset class, a domestic mid-cap equity asset class, and a domestic small cap equity asset class. A multidimensional constraint matrix may be implemented to reflect these equality and non-equality constraints.

The goals of the allocation determination are to maximize excess returns, minimize volatility, and meet the applicable constraints. If an allocation solution meets a threshold of index level deviation, then the allocation has been determined. If the allocation solution does not meet the threshold of index level deviation, then the threshold of index level deviation may be relaxed, and the process may be repeated.

The allocation determination is repeated on a periodic basis. For example, the allocation determination may be repeated on a monthly basis, although the periods between determinations may be longer or shorter.

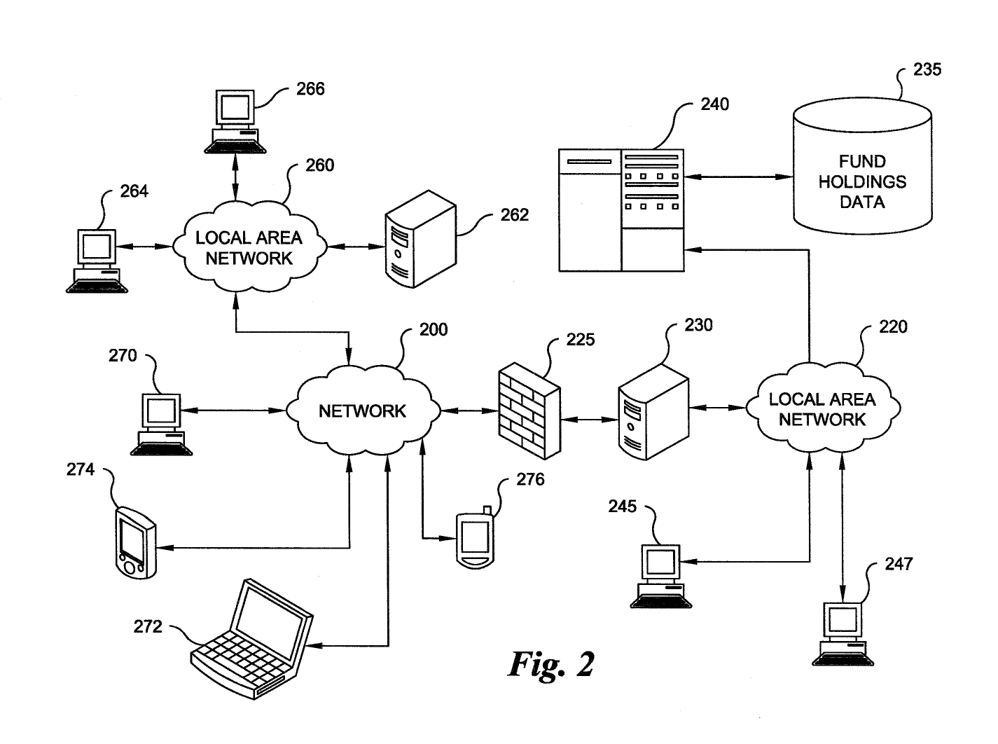

Referring to FIG. 2, an exemplary network configuration is shown. Network 200 connects various computer systems and devices. Network 200 may be or include any type of network, including a local area network (LAN), a wide area network (WAN), an intranet, the Internet, a public switched telephone network (PSTN) or other network. Network 200 may employ any suitable data protocols.

Various devices and networks may be in communication with network 200. In embodiments, client device 270, a desktop computer system, client device 272, a notebook computer system, and client device 274, a personal digital assistant, and client device 276, a smart phone, are in communication with network 200. Client devices 270, 272, 274 are merely exemplary. Local area network (LAN) 260 is an exemplary network of an entity such as a fund management company. LAN 260 has in communication therewith desktop computer systems 264, 266, and file server 262. File server may store data relating to holdings of the funds managed by the management company.

LAN 220 may be a network of a manager of funds of funds, by way of example. Firewall unit 225 may be configured to provide data security services with respect to systems and networks, LAN 220 and the devices in communication therewith. Firewall unit 225 may be a stand alone device including one or more processors, data storage devices, and input and output connections. Server 230 may serve as a front-end web server that formats and serves web pages to client devices running browser software. In an embodiment, a processor of server 230 may execute steps of a method of generating display data to prompt users at client devices to upload data or to administer analysis of holdings data, and to generate display data to present determined fund allocations to users at client devices. In an embodiment, server 230 may function as a web front-end for another device or system, such as server 240, which may execute steps of a method of determining optimized fund allocations, employing fund holdings data stored in data storage devices, such as exemplary data storage device 235. Server 230 may provide the functionality of a graphical user interface generation module discussed in greater detail herein. Server 240 may provide the functionality of one or more of the processing modules, data access modules and communication modules discussed in greater detail herein. The term “module,” as used herein, includes computer hardware, including processors and memory devices, having loaded program code causing the processor and other devices to perform particular functions. Server 240 may receive instructions for performance of allocation optimization determinations from client devices via web server 230, perform analyses of allocation data stored in data storage device 235 to determine excess returns and correlations, develop correlation matrices and constraint matrices, and perform optimization analyses. Server 240 may generate displays of the optimization analyses, and provide the displays to web server 230 for communication to client devices for display. Local client devices 245, 247 may be workstations of users such as employees of fund management company that maintains server 240 and claims data storage devices 235. Users employing local client devices 245, 247, may access server 240 via local area network 220. While local client devices 245, 247 are depicted as desktop personal computer systems, local client devices 245, 247 may be any suitable client device, including thin clients, smart phones, personal digital assistants, and other devices.

In embodiments, a network or data processing network, such as network 200, may be employed which may include a plurality of individual networks, such as a wireless network and a landline based network, each of which may include a plurality of servers, individual workstations or personal computers. Additionally, as those skilled in the art will appreciate, one or more LANs may be included where a LAN may include intelligent workstations coupled to a host processor. The networks may also include mainframe computers or servers, such as a gateway computer or application server. A gateway computer serves as a point of entry into each network. The gateway may be coupled to another network via one or more communications links. The gateway may also be directly coupled to one or more workstations using a communications link. The gateway computer may also be coupled to a storage device for storing information related to insurance claims. Further, the gateway may be directly or indirectly coupled to one or more workstations. Those skilled in the art will appreciate that the gateway computer may be located geographically remote from the network, and similarly, the workstations may be located geographically remote from the networks and/or network servers. The client devices or workstations may connect to the wireless network using a networking protocol such as the Transmission Control Protocol/Internet Protocol (“TCP/IP”) over a number of alternative connection media, such as cellular phone networks, radio frequency networks, satellite networks, etc. The wireless network may connect to the gateway using a network connection a such as TCP (Transmission Control Protocol) or UDP (User Datagram Protocol) over IP, X.25, Frame Relay, ISDN (Integrated Services Digital Network), PSTN (Public Switched Telephone Network), etc.

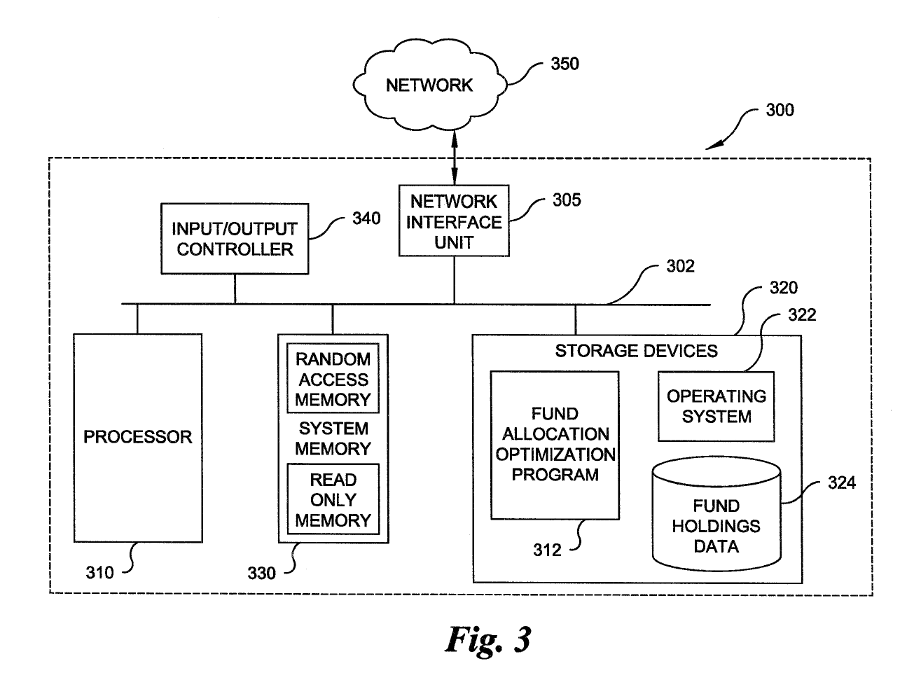

Referring to FIG. 3, an exemplary computer system 300 for use in an implementation of the invention will now be described. In computer system 300, processor 310 executes instructions contained in programs such as fund allocation optimization application program 312, stored in memory storage devices 320. Memory storage devices 320 may include suitable media, such as optical or magnetic disks, fixed disks with magnetic storage (hard drives), tapes accessed by tape drives, and other storage media. Processor 310 communicates, such as through bus 302 and/or other data channels, with network interface unit 305, system memory 330, memory storage devices 320 and input/output controller 325. Via input/output controller 325, processor 310 may receive data from user inputs such as pointing devices, touch screens, audio inputs and keyboards, and may provide data to outputs, such as data to video drivers for formatting on displays, and data to audio devices. Processor 310 may be configured to provide an output signal indicative of determined investment selections, for display on a user display, or for transmission via network interface unit 305 to other devices, by way of example. Memory storage devices 320 are configured to exchange data with processor 310, and may store programs containing processor-executable instructions, and values of variables for use by such programs. Memory storage devices 320 may include local and network accessible mass storage devices. Memory storage devices 320 may include media for storing operating system 322 and mass storage devices such as fund holdings data database 324 for storing data related to current and historical holdings of funds by asset class. Fund holdings data database 324 may include data indicative of asset class exposure for funds at various points in time. For example, fund holdings data database 324 may include data indicative of asset class performance and asset class exposure for funds at monthly, weekly, daily or other intervals for periods of one year, three years, five years, ten years, or other periods. Fund holdings data database 324 may include identification of individual securities held by the funds, at various intervals in the past, and a table or similar data correlating individual securities with asset classes. In an embodiment, the holdings by asset class for the funds may have been derived using a regression analysis. Database 324 may further include fund identification data, fund of funds data for determination of constraints, such as target exposures to debt and equity, and ranges of percentages of asset classes and categories of asset classes. In an embodiment, inputs may include user interfaces, including workstations having keyboards, touch screens, pointing devices such as mice, or other user input devices, connected via networked communications to processor 310. Network interface unit 305 may communicate via network 350 with remote sources of data, such as data relating to holdings of funds and values of holdings, and computer systems of entities providing data, such as investment management firms, and with systems for implementing instructions output by processor 310. Network 350 may be or include wired or wireless local area networks and wide area networks, and over communications between networks, including over the Internet. Any suitable data and communication protocols may be employed.

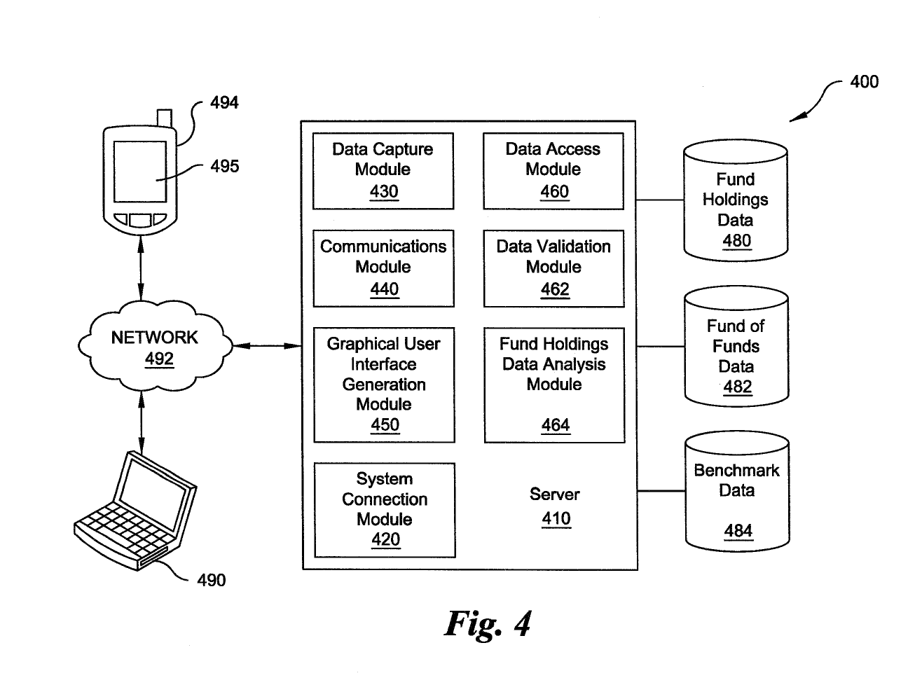

Referring now to FIG. 4, a system 400 for determining fund allocations for a fund of funds and furnishing data indicative of determined fund allocations to a client device is shown. System 400 may operate to provide data to any suitable client device, including without limitation the exemplary client devices 490, 494, illustrated in FIG. 4. System 400 includes hardware server 410 which is configured to implement one or more modules. A user employing client device 490, 494 communicates with system 400 via network 492. Client devices 490, 494 may be granted access to system 400 by system connection module 420, which may verify credentials such as user identification and password. Data access module 460 is configured to, responsive to a request from a user device, access current and historical fund holdings data, fund of funds data, including applicable constraint data, and other data, from a database, such as databases 480, 482, 484.

Data access module 460 is configured to access data from databases 480, 482, 484, including data related to fund holdings. In the embodiment, the fund data, fund of funds data, and benchmark investment performance data or benchmark return data are in separate databases 480, 482, 484. The separate databases may be separate logical databases on the same data storage device or devices, or may be maintained in separate data storage devices. In other embodiments, the data may be maintained in a single database, or in a different number of databases and distributed in two or more databases along logical divisions other than the divisions illustrated in FIG. 4. In an embodiment, the databases may be implemented in any suitable relational database management system, such as Oracle or Microsoft SQL server. In an embodiment, suitable SQL queries may be stored in software code in one or more memory devices by data access module 460 and accessed by data access module 460 in response to a user or system request for data, such as value of securities in a particular asset class of a particular fund on a particular date. In another embodiment, queries may be stored in databases 480, 482, 484, and may be accessed by data access module 460.

Data accessed by data access module 460 may be furnished to graphical user interlace generation module 450. Graphical interface generation module 450 may have associated therewith one or more templates for presentation of data accessed by data access module 460. Graphical user interface generation module 450 may populate a selected template with the accessed data and transmit the populated template for display on a client device. In an embodiment, a communications module may provide output signals including, for example, optimized fund selections for a fund of funds.

System connection module 420 provides authentication and data security services. System connection module 420 performs functions of authenticating users for access to a computer system for analysis of fund performance and determination of optimal holdings for funds of funds. System connection module 420 also performs other firewall functions, such as identification and neutralizing of malicious code and other attacks. In an embodiment, a system connection module may be implemented on the server and perform functions of authenticating users and permitting connection to system components. In an embodiment, a system connection module may be implemented on a standalone device including one or more processors and memory devices storing code having instructions which, when executed by the one or more processors, causes the one or more processors to perform authentication and firewall functions.

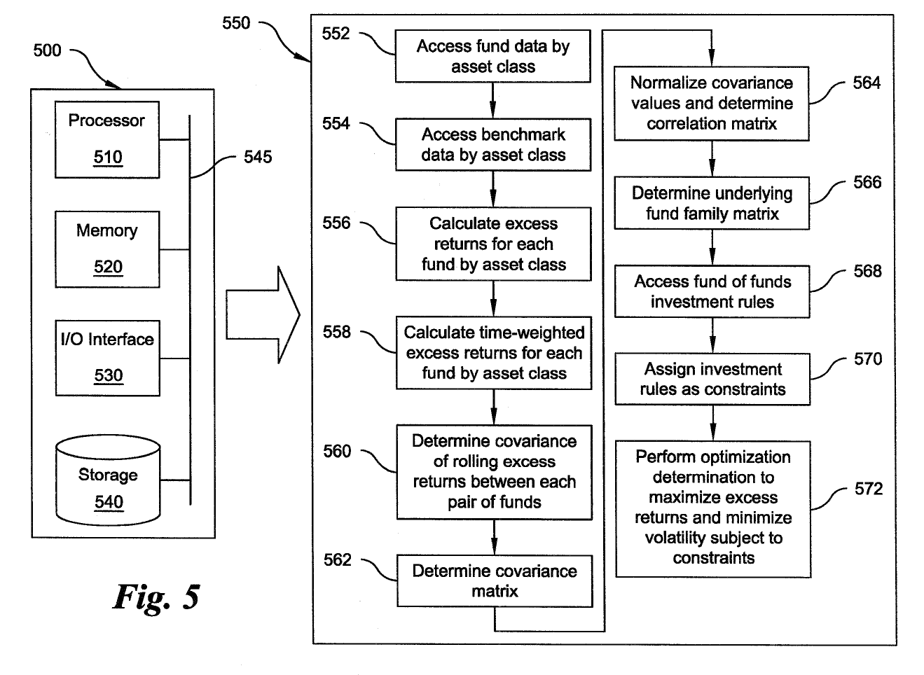

Referring now to FIG. 5, an exemplary process flow executed by a computer system is shown. Computer system 500 has processor 510 in communication, via bus 545, with local memory 520, input/output interface 530, and data storage 540. Instructions stored in memory, such as in data storage 540 and loaded into local memory 520, when executed by processor 510, cause processor 510 to execute the steps of process flow 550. In process flow 550, the processor accesses 552 data regarding fund holdings and particularly holdings by asset class. A non-limiting example of asset classes is: large cap growth, large cap value, mid cap growth, mid cap value, small cap growth, small cap value, U.S. real estate investment trusts (REITs), international stocks, international small cap stocks, emerging market stocks, international REITs, commodities, intermediate term bonds, Treasury inflation-protection securities (TIPS), short term bonds, cash, high yield bonds, floating rate notes and emerging market debt. The accessed data may be over a selected period of time for which excess returns are to be calculated. For example, excess returns may be calculated for three month, six month, nine month, twelve month, eighteen month, one year, two year and five year periods. The processor accesses 554 benchmark data regarding performance of benchmarks of asset classes for the same periods. The benchmarks may be, for example, data concerning one or more indices corresponding to an asset class, or averaged or median data of funds investing in an asset class.

The processor may then calculate 556 excess returns for a fund for each relevant asset class. Excess returns are returns obtained by the fund for a particular asset class in excess of the benchmark returns for that period. Excess returns may be calculated for a number of time periods of differing durations. In an embodiment, the time weighted excess returns may be based on at least one multi-year time period and one time period of less than a year, two time periods of less than a year, one time period of less than a year and one time period of a year or about a year; in other embodiments, other combinations of durations may be employed. The calculation may be a simple arithmetic calculation. Rolling excess returns may be calculated, such as excess returns for each month in a time period of twelve months. The process may then determine 558 time weighted excess returns for each fund for each asset class. An exemplary formula for time weighting of excess returns may be:

Σ((1*QuarterExcessReturn)+(2*One−YearExcessReturn)+(3*Three−YearExcessReturn))/6

In this formula, both short term, such as one quarter, and long term, three year returns are considered. This exemplary formula weights short term returns more heavily than long term returns, as the quarter returns are incorporated in the one year and three year excess returns.

The processor may then determine 560 the covariance of the rolling excess returns over a selected time period between each pair of funds. The determination of covariance between two variables is well known. In embodiments, other measures of the dependence between the rolling excess returns may be employed. Rolling excess returns for monthly periods over a time span of one year, two years or three years may be employed, for example. The processor may determine 562 a covariance matrix for presentation of the results. The processor may normalize the values from the covariance matrix and present the resulting values in a correlation matrix. For example, in the correlation matrix, the values may be presented on a selected scale, such as between +1.00 and −1.00. A value of +1.00 indicates perfect correlation between asset classes, and a value of −1.00 indicates perfect inverse correlation. The populated correlation matrix constitutes correlation data determined by the processor. The populated correlation matrix represents data indicative of similar investments between funds

The processor may create 566 an underlying fund family matrix. An underlying fund family matrix reflects the proportion of exposure to each asset class in each underlying fund. The underlying fund family matrix is employed in determining the matching of an allocation to the desired allocations of the fund of funds to asset classes.

The process may access 568 fund of funds investments rules. The fund of fund investment rules may include asset class values or ranges for the fund of funds. The asset class values may be precise percentages of assets of the fund of funds, or may be ranges of percentages of assets of the fund of funds. A further investment rule may be maximum exposure to asset class categories. Asset class categories may include, for example, domestic stock, which would include all asset classes for domestic stocks, including large, mid and small capitalization, and international stock. The variation or deviation from these rules, which may be termed the index level deviation, may be set at a maximum.

The processor may assign 570 the investment rules as constraints for use in an optimization calculation. The processor may perform 572 an optimization determination. The optimization determination may use quadratic programming in which total excess returns are to be maximized, and the correlation values and index level deviation are to be minimized, so as to provide a maximum return and minimize the portfolio variance and the variance from target allocations. The excess return matrix and the correlation matrix values are used as inputs.

In quadratic programming, equality constraints and inequality constraints are applied. The equality constraints require, for the fund of funds, that the assets of the fund of funds be allocated across available investments so that the exposure for the fund of funds adds to 100%, and that any asset class and asset category rules for the fund of funds must be followed. A turnover constraint is also applied, which limits the maximum change from the previous period's investments. For example, the turnover constraint may be a maximum percentage, such as 3%, of invested assets. The turnover constraint may be expressed in other forms, such as by constraining total dollar value of turnover from a prior period, or by applying the constraint over several periods, such as a total limit of 9% over three periods. It will be noted that the fund of funds should have holdings only in the underlying funds that are included in the analysis. There are various software packages available for implementation of suitable quadratic programming methods. These software packages may be used by those of ordinary skill in the art, together with the data and constraints described above, to perform the optimization calculations.

The result of the optimization calculation may be stored to storage 540 and output via I/O interface for display, printing and transmission via networks for storage and display on devices in communication with system 500.

In an embodiment, the optimization calculation may be re-run with a constraint relaxed or tightened. For example, the index level deviation constraint may be tightened or relaxed, and the optimization calculation repeated. One of the optimized calculations may then be selected.

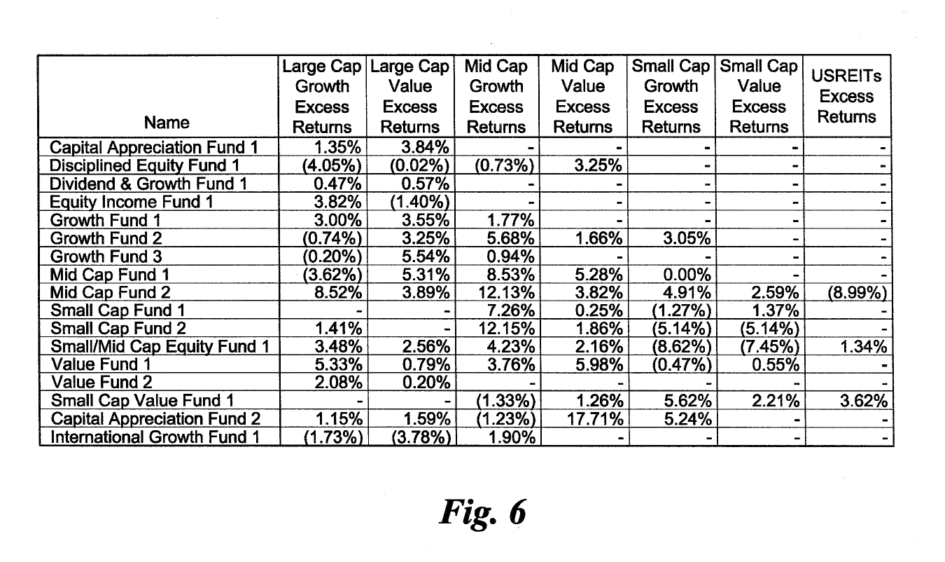

Referring to FIG. 6, there is shown an exemplary table showing weighted excess returns by asset class for selected funds. By comparing the weighted excess returns, it can be seen that the managers of the same fund appear to have greater skill with respect to certain asset classes, i.e., those in which the excess returns show gains, than other asset classes, i.e., those in which the excess returns show losses.

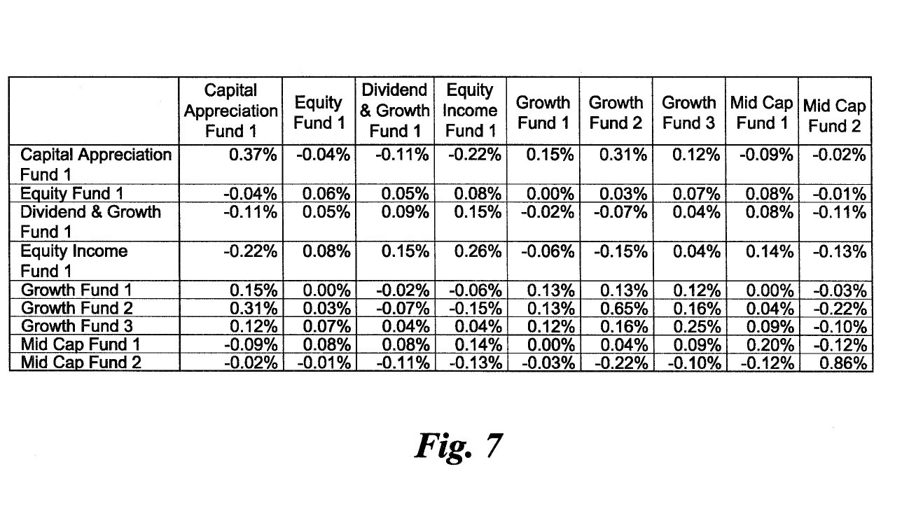

Referring to FIG. 7, an exemplary covariance matrix is shown, which indicates covariances of rolling excess return data between pairs of funds.

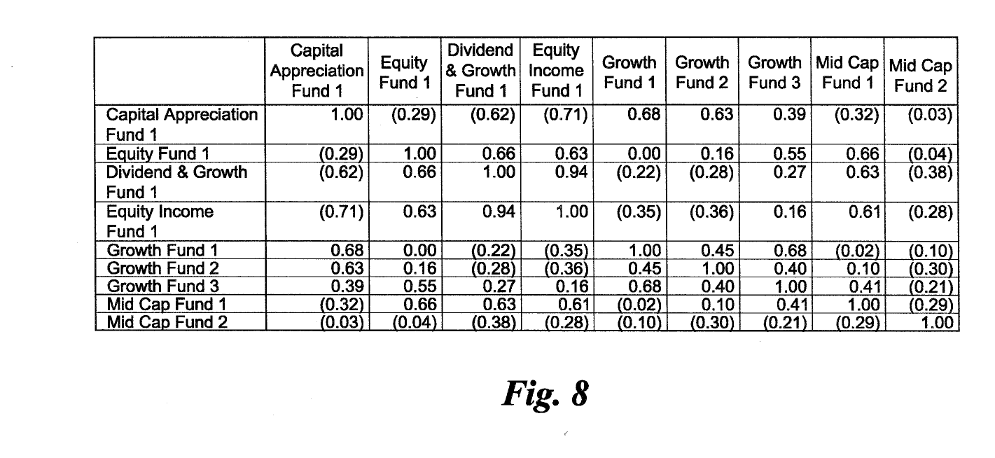

Referring to FIG. 8, an exemplary correlation matrix is shown, indicating correlations between excess return data for pairs of funds. Pairs of funds that are highly correlated are closer to the value 1.00. A fund compared to itself necessarily has a correlation value of 1.00. Pairs of funds that have little correlation between results have values closer to 0.0. Pairs of funds that show negative correlation have values closer to −1.00. In minimizing volatility, the optimization process seeks to reduce allocations to the same fund and to avoid allocations to different funds that have a high correlation within asset classes.

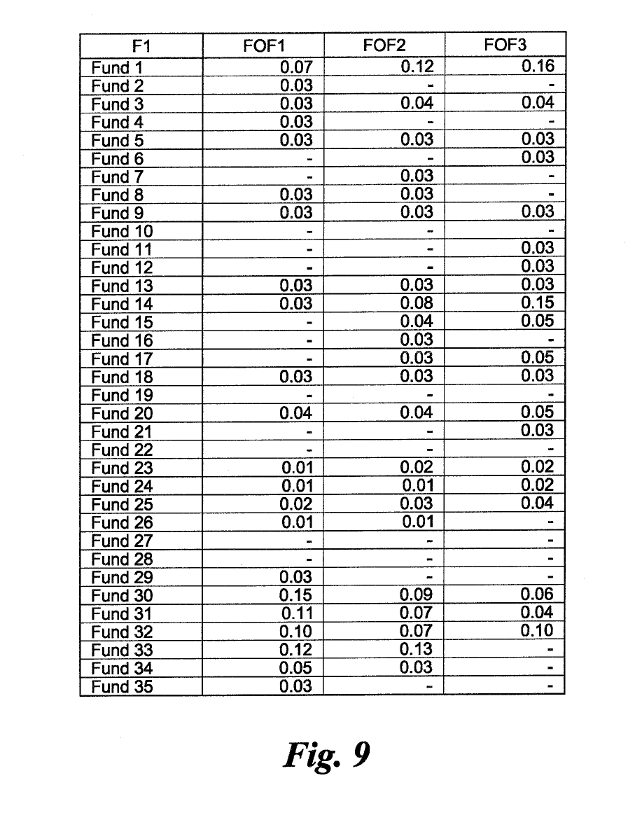

Referring to FIG. 9, a table is provided showing an exemplary allocation resulting from an embodiment of the optimization method disclosed herein. In this example, three funds of funds, designated as FOF1, FOF2 and FOF3, have asset proportions for 35 funds, indicated as Fund1 to Fund35. The differences in the allocations reflect differences in the funds of funds. The differences among the funds of funds may be as to target asset class allocations, maximum and minimum asset category allocations, and current holdings in Fund1 to Fund35. The exemplary data of FIG. 9 is the data stored and output by computer system 500 of FIG. 5, for example. The data shown in FIG. 9 is an example of a determined optimized allocation of holdings of a fund of funds in managed investment funds.

Embodiments of the present invention are operable with computer storage products or tangible computer readable media that contain program code for causing a processor to perform the various computer-implemented operations. The tangible computer-readable medium is any data storage device that can store data which can thereafter be read by a computer system such as a microprocessor. The media and program code may be those specially designed and constructed for the purposes of the present invention, or they may be of the kind well known to those of ordinary skill in the computer software arts. Examples of tangible computer-readable media include, but are not limited to magnetic media such as hard disks, floppy disks, and magnetic tape; optical media such as CD-ROM disks; magneto-optical media; and specially configured hardware devices such as application-specific integrated circuits (ASICs), programmable logic devices (PLDs), and ROM and RAM devices. Examples of program code include both machine code, as produced, for example, by a compiler, or files containing higher-level code that may be executed using an interpreter. Steps in the computer-implemented methods may be implemented in processors running software stored locally, and/or in configurations such as application service providers, in which certain steps are executed on processors communicating with one another over a network such as the Internet. Either stand-alone computers or client/server systems, or any combination thereof, may be employed.

A system in accordance with the invention may include means corresponding to each step in each method described herein. Each means may be implemented by a processor executing instructions contained in programs which may be stored in a storage medium, such as a magnetic or optical storage medium. The instructions may, when executed by a processor, cause the processor to execute algorithms disclosed in association with each step. It will be appreciated that any of the steps in the methods in accordance with the invention described herein may be so implemented.

An exemplary advantage of a system and method in accordance with an embodiment is that selections of underlying fund holdings for a fund of funds may be made based on identifying funds with superior performance in appropriate investment categories and avoiding volatility associated with funds having excessively similar investment decisions. The use of excess returns for underlying funds by asset class permits identification of varying skills of investment managers in different asset classes, and taking those skills into consideration. The determination may also be guided by target asset allocations, and take into consideration current holdings of the funds of funds.

While the foregoing invention has been described with reference to the above embodiments, various modifications and changes can be made without departing from the spirit of the invention. Accordingly, all such modifications and changes are considered to be within the scope of the appended claims.

What is claimed is:

1. A computer system for determining investment selections in managed investment funds for a fund of funds, comprising:
a data access module configured to access from a memory device data relating to holdings of the investment funds over time, the data including data relating to asset classes held by the investment funds; investment fund holdings of the fund of funds, and investment rules of the fund of funds;
a processing module configured to: based on the accessed data relating to the holdings over the investment funds over time, determine performance data of the investment funds in a plurality of asset classes held by the investment fund and data indicative of similar investments between funds, and, based on the performance data, the similar investment data, the investment fund holdings of the fund of funds, and the investment rules of the fund of funds, determine investment selections for the fund of funds optimized to maximize returns and minimize volatility;
a communications module for outputting the determined investment selections; and
a processor configured to execute instructions furnished by each of the modules.

2. The computer system of claim 1, wherein the processing module is further configured to determine performance of the investment fund by comparing returns over one or more time periods in each one of the asset classes held by the investment fund to a benchmark return, over the one or more time periods, in the asset class.

3. The computer system of claim 2, wherein the processing module is further configured to compare returns by determining excess returns relative to the benchmark returns in each of the asset classes for each of the one or more time periods.

4. The computer system of claim 3, wherein the time periods include time periods of differing durations.

5. The computer system of claim 2, wherein the benchmark return is a return of an index corresponding to one of the asset classes.

6. The computer system of claim 1, wherein the determining data indicative of similar investments between funds comprises determining covariance data of excess returns of pairs of the investment funds.

7. The computer system of claim 6, wherein the investment rules include target asset allocations and current fund holdings.

8. A computer-implemented method for determining allocations of a fund of funds to managed investment funds, comprising:
accessing by a processor from a memory storage device data relating to holdings of the managed investment funds over time, the data including data relating to asset classes held by the investment funds; benchmark performance data; investment fund holdings of the fund of funds, and investment rules of the fund of funds;
based on the accessed data relating to the holdings over the investment funds over time and the benchmark performance data, determining by the processor performance data of the investment funds in a plurality of asset classes held by the investment fund and data indicative of similar investments between funds, and, based on the performance data, the similar investment data, the investment fund holdings of the fund of funds, and the investment rules of the fund of funds, determining by the processor investment selections for the fund of funds optimized to maximize returns and minimize volatility; and
providing by the processor, for display on a user display in communication with the processor, an output signal indicative of the determined investment selections.

9. The computer-implemented method of claim 8, wherein the benchmark performance data comprises index data.

10. The computer-implemented method of claim 9, wherein the determining the performance data comprises determining excess returns relative to the returns from the benchmark performance data in each of the asset classes for each of a plurality of time periods.

11. The computer-implemented method of claim 10, wherein the determining the performance data further comprises determining weighted excess returns of at least two time periods of differing duration.

12. The computer-implemented method of claim 8, wherein the determining the similar investment data comprises determining covariances between rolling excess return data for pairs of the investment funds.

13. A tangible computer-readable medium having stored thereon computer-readable instructions, which instructions, when executed by a processor, cause the processor to:
access from a memory storage device in communication with the processor data relating to holdings of managed investment funds over time, the data including data relating to asset classes held by the managed investment funds; and benchmark return data for the asset classes;
determine time weighted excess returns of the managed investment funds with respect to each of the asset classes based on the accessed data;
determine correlation data between excess returns of the managed investment funds based on the accessed data;
access, for a fund of funds having holdings only in the managed investment funds, data including current holdings in the managed investment funds and target allocations by asset class;
determine an optimized allocation of holdings of the fund of funds in the managed investment funds, by maximizing the time weighted excess returns, minimizing volatility using the correlation data, and employing the accessed fund of funds data as constraints; and
provide an output signal indicative of the determined optimized allocation.

14. The tangible computer-readable medium of claim 13, wherein the accessed fund of funds data further comprises minimum and maximum exposures to categories of the asset classes.

15. The tangible computer-readable medium of claim 13, wherein the constraints comprise a range of allocations around the target allocations.

16. The tangible computer-readable medium of claim 15, wherein the constraints comprise a maximum change in holdings of the fund of funds.

17. The tangible computer-readable medium of claim 13, wherein the time weighted excess returns are based on at least one multi-year time period and one time period of less than a year.

18. A computer system for determining allocations of a fund of funds to managed investment funds, comprising:
a processor;
a memory storage device in communication with the processor; and
an input/output controller in communication with the processor;
wherein the processor is configured to:
access from the memory storage device data relating to holdings of managed investment funds over time, the data including data relating to asset classes held by the managed investment funds; and benchmark return data for the asset classes;
determine time weighted excess returns of the managed investment funds with respect to each of the asset classes based on the accessed data;
determine correlation data between excess returns of the managed investment funds based on the accessed data;
access from the memory storage device, for a fund of funds having holdings only in the managed investment funds, data including current holdings in the managed investment funds and target allocations by asset class;
determine an optimized allocation of holdings of the fund of funds in the managed investment funds, by maximizing the time weighted excess returns, minimizing volatility using the correlation data, and employing the accessed fund of funds data as constraints; and
provide via the input/output controller an output signal indicative of the determined optimized allocation.

19. The computer system of claim 18, wherein the accessed fund of funds data further comprises minimum and maximum exposures to categories of the asset classes.

20. The computer system of claim 18, wherein the constraints comprise a range of allocations around the target allocations.
